(19) United States
(12) Patent Application Publication
(10) Pub. No.: US 2002/0006211 A1
(43) Pub. Date: Jan. 17, 2002

(54) Directional microphone

(76) Inventor: Mike Geskus, Amsterdam (NL)

Correspondence Address: BIRCH STEWART KOLASCH & BIRCH, PO BOX 747, FALLS CHURCH, VA, 22040-0747, US

(21) Appl. No.: 09/899,197

(22) Filed: Jul. 6, 2001

Related U.S. Application Data
(60) Provisional application No. 60/216,463, filed on Jul. 6, 2000.

(51) Int. Cl. H04R 9/08; H04R 11/04

(52) U.S. Cl. 381/356

(57) ABSTRACT

A directional microphone assembly comprising a surface part having at least two inlet holes for sound, a microphone having at least two sound inlets, and means for transporting sound from each inlet hole to a respective sound inlet, where the transporting means are hollow and at least substantially rigid. The microphone assembly may be used in directional microphones such as for use in hearing aids. The advantage of using rigid transporting means is seen in that the assembly may simply be forced against a face plate instead of soft tubes having to be assembled thereto. It is further described how the shape of the rigid transporting means (e.g. the diameter, the inner surface and the curvature) influences the frequency response and directionality of the tubing and how the diameter of the inlet hole influences the directionality.

The present invention relates to an improved directional microphone.

Prior art directional microphones for e.g. hearing aids have hitherto been assembled from a two-inlet microphone, a faceplate having sound inlet holes and flexible tubing for transferring sound from the inlet holes to the two inlets in the microphone. The inlets in the microphone are respectively acting as the sound passage for front volume and back volume. The assembly of these elements is highly labour intensive, and the present invention relates to an improvement thereof. A further problem with prior art is when using the microphone in an application, such as a hearing aid, it is often necessary to tune the application after installation of the microphone in order to optimise the frequency response of the tubing for transferring sound and also to adjust the directionality, this can be both troublesome and time-consuming for the manufacturer of the application.

In a first aspect, the invention relates to a directional microphone assembly comprising:

a surface part, such as a so-called faceplate, having at least two inlet holes for sound,

a microphone having at least two sound inlets,

means for transporting sound from each inlet hole to a respective sound inlet,

where the transporting means are hollow and at least substantially rigid.

Thus, instead of providing flexible tubing, more rigid tubing is provided which facilitates the connection of the microphone with the faceplate. Various shapes of the tubing can be manufactured, depending for example on the shape of the faceplate the directional microphone unit will be assembled with. Further the shape of the tubing (e.g. the diameter, the inner surface and the curvature) influences the frequency response of the tubing.

In the present context, “at least substantially rigid” will mean that the transporting means are substantially rigid for them to at least substantially retain their shape even when slightly forced against the surface (such as with a force of at least 1/2N, such as at least 1, 2, 3, and/or 4N). The transporting means may be made of any material, such as plastics and any type of metal.

The inner diameter of the hollow transporting means are dimensioned in such a way that the frequency response of the transporting means are optimised. Thereby it is possible to avoid using grids or other means to alter the frequency response.

In an embodiment damper grids are placed on an inner surface of the mean for transporting sound to the inlet which is acting as the sound passage for front volume. By placing these damper grids in the sound passage for the front the entrance of debris/foreign material (such as dust, sweat, small particles etc.) into the microphone will be significantly limited. If debris enters into the microphone, it could f.ex. settle on the backplate or membrane of the microphone, since those parts of the microphone are electrically charged. This will damage the microphone or at least have a negative effect on its performance. Further in microphone assemblies of more than one microphone that share one front tube as a sound passage for both microphones, it is an advantage to place the grid in the shared front sound passage. This is an advantage since the grid also functions as damping means, so the same damping will occur for both microphones, resulting less difference between the frequency response of the microphones in the one assembly.

In a specific embodiment the diameter of the at least two inlet holes for sound are dimensioned in accordance with a required directionality. This is an easy way to adjust the directionality.

Especially when the transporting means are attachable or attached to the microphone, an advantage is seen in that the microphone and transporting means may be provided as a unit. In this manner, this unit may simply be positioned at or forced toward the surface or faceplate of the microphone, where after the assembly may be completed. This advantage doesn't only apply to microphone units assembled to a faceplate, but also other (directional) microphone assemblies that require tubing.

This attachment may be clicking the parts together, gluing, soldering, or welding, such as laser welding. Also, the transporting may be formed in one piece with a constructional part of the microphone. A preferred embodiment is one wherein at least one of the transporting means comprises an acoustical sound-delaying filter. Normally this filter is adapted to a distance between the sound inlets in the surface. Normally, the filter produces a delay corresponding to the time delay experienced by sound while travelling from one sound inlet in the surface to another. Alternatively, the filter may be adapted to “enhance” sound from other angles or directions of incidence.

Providing the microphone with attached rigid transporting means will make it harder for the user to err in the manufacture in the assembly of the microphone. The tubing is predetermined, hence the distance between the inlet holes is predetermined, hence the required sound-delaying filter is easy to determine, so that the transporting means and the filter may be adapted to each other.

In one embodiment, the directional microphone assembly comprises a surface having two sound inlets, a microphone having two sound inlets and two transporting means.

In a second aspect, the invention relates to a hearing aid comprising:

a surface part, such as a so-called faceplate, having at least two inlet holes for sound,

a microphone having at least two sound inlets,

hollow and at least substantially rigid means for transporting sound from each inlet hole to a respective sound inlet.

Especially in relation to small directional microphones such as for use in hearing aids, the assembly of a microphone with separate flexible tubing becomes extremely difficult and labour intensive. Providing rigid tubing facilitates assembly in a convenient manner. Due to the connection of the transporting means to the microphone, acoustical mass is added to the directional microphone device. This will alter or influence the frequency response of the transporting means. This may be compensated by providing transporting means having different inner diameters. In general, the frequency response of the transporting means may be tailored or adapted by altering or selecting inner or outer diameters and/or shapes or materials thereof. Also, the tubing influences the frequency response and therefore indirectly the directivity. Therefore, the microphone manufacturer can optimise/customise the directivity, which shortens the design time for the hearing aid manufacturer. In essence, the invention can be seen as a “plug & play” device for hearing aid manufacturers.

Also, in a third aspect, the invention relates to a microphone assembly for use in the above hearing aid, the assembly comprising:

a microphone having at least two sound inlets,

hollow and at least substantially rigid means attached to the microphone and being adapted to transport sound from predetermined positions to a respective sound inlet.

Again, the transporting means may be adapted to abut or engage e.g. an element defining the surface part having therein sound inlet holes—and at least one of the transporting means may comprise an acoustical sound-delaying filter—such as a sound-delaying filter being adapted to delay sound by a period of time at least substantially corresponding to a distance between two predetermined positions divided by the velocity of sound in air at sea level. Normally, a directional microphone is adapted to detect sound especially from a particular direction in relation to a direction from one inlet hole to another. Normally, this particular direction is the direction from one hole to the other. However, any direction may be selected—and the filter should merely be adapted to that direction.

This assembly may be provided with specific dimensions and spacing between the transporting means. Also, the transporting means may be provided with distal openings shaped so as to at least substantially lie within a single plane in order to be adapted to engage a plane element defining the surface part having the sound inlet holes. In this manner, the spacing between the sound inlets in the surface part may be selected to be any spacing. For hearing aids, a distance of 4 mm is normal. However, distances may easily be increased to e.g. 8 mm or more.

Preferably the acoustical sound-delaying filter is adapted to provide a sound delay corresponding to 0.33-0.57 times a distance between two inlet holes in the surface part divided by the speed of sound. A delay in that interval will provide supercardioid or hypercardioid directional responses which are presently desired in directional hearing aids (instead of old-fashioned models that usually were tuned for cardioid (heart shaped) responses).

In the following, preferred embodiments of the invention will be described with reference to the drawings wherein:

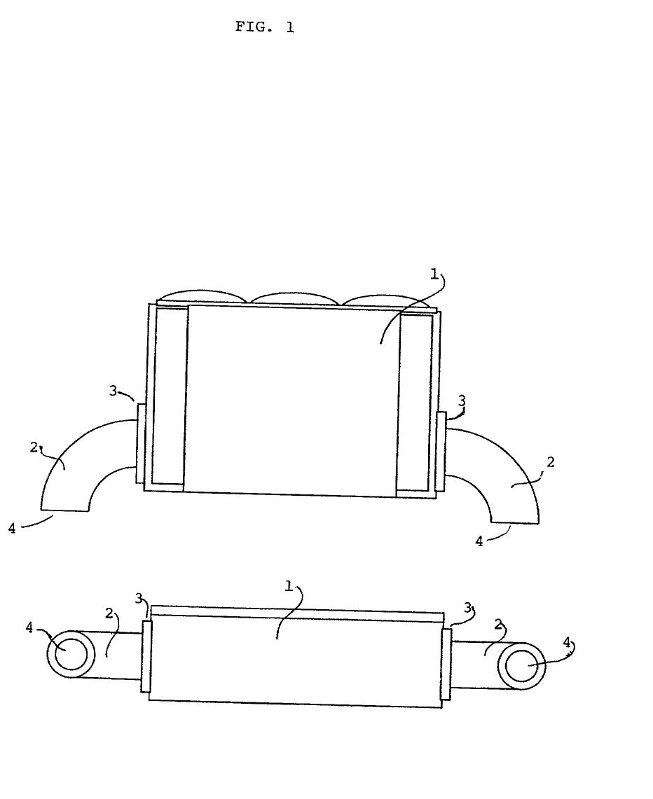

FIG. 1 illustrates, as a side view and a top view, a first embodiment,

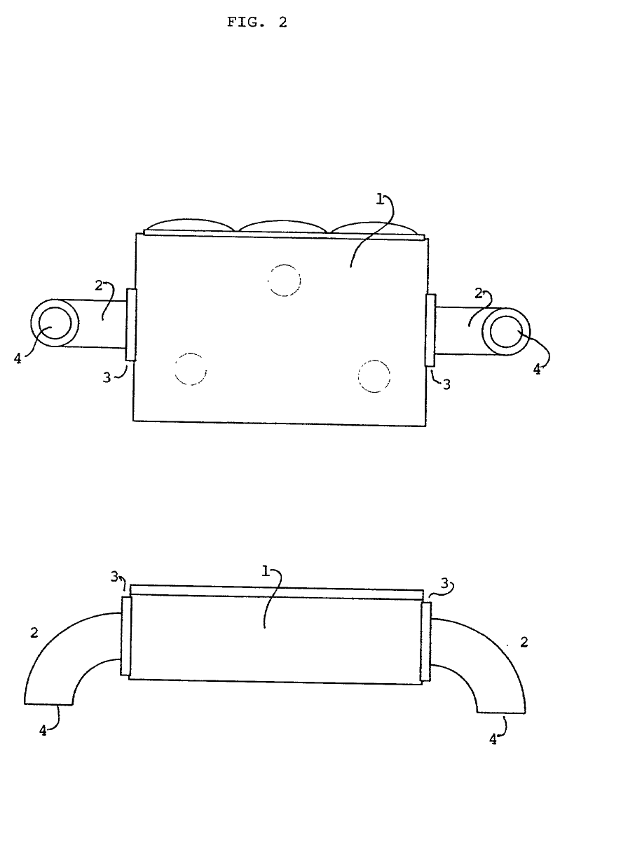

FIG. 2 illustrates, as a side view and a top view, a second embodiment, and

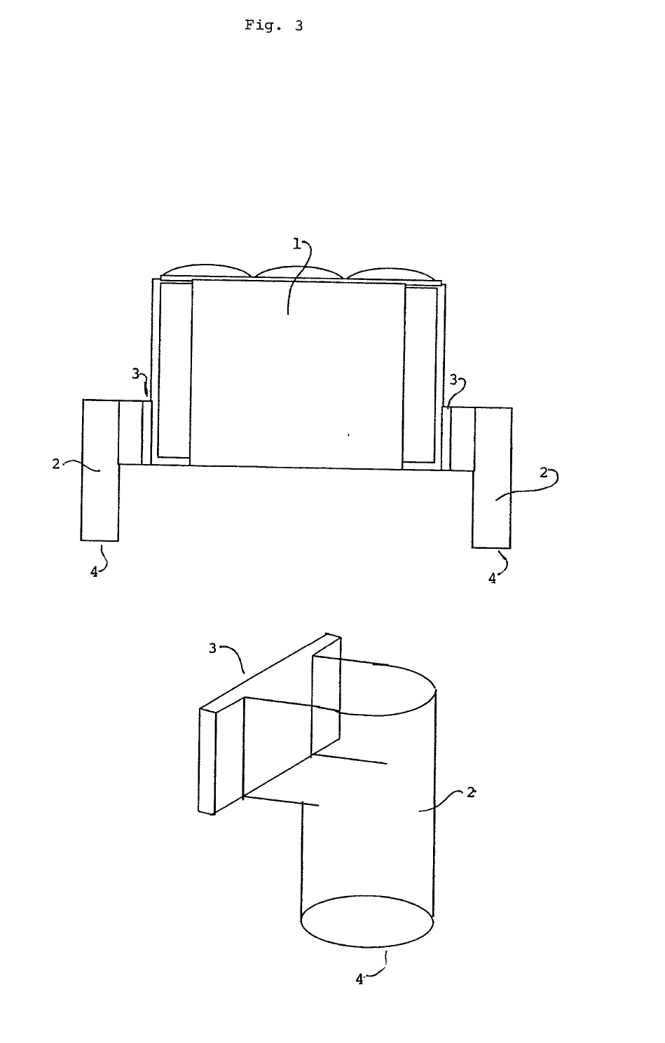

FIG. 3 illustrates a side view of a third embodiment and a perspective view of a corresponding transport means.

FIG. 1 illustrates a microphone 1 having two sound inlets and two hollow, rigid transporting means 2 fixed to the microphone 1. The transporting means 2 have two inlets 3 and 4 where the inlets 3 are positioned adjacent to sound inlets of the microphone 1 and the inlets 4 are positioned with a predetermined distance there between and having shapes and positions adapted to engage e.g. an element (not shown) having a flat surface part having therein sound inlet holes for sound to travel from one side of the element, through the holes, and into the transporting means 2.

In FIG. 1, the transporting means 2 are adapted to require the mounting or fixing of the microphone 1 in one manner or direction. In FIG. 2, which illustrates an embodiment similar to that of FIG. 1 where the transporting means have been rotated, whereby this assembly requires fixing or mounting in another manner or direction—a direction requiring a smaller depth away from the openings 4.

The embodiment of FIG. 3 is similar to that of FIG. 1 with the exception that the transporting means 2 in FIG. 1 are curved, bent tubular elements having a circular cross section and where the transporting means 5 of FIG. 3 have a different shape.

In all three embodiments, the distance between the inlets may be e.g. 4 mm . Nevertheless, the distance between the inlets 4 may be chosen to be e.g. 8 mm in order to increase the S/N of the assembly.

1. A directional microphone assembly comprising:
a surface part having at least two inlet holes for sound,
a microphone having at least two sound inlets,
means for transporting sound from each inlet hole to a respective sound inlet,
characterised in that the transporting means are hollow and at least substantially rigid.

2. An assembly according to claim 1, wherein the inner diameter of the hollow transporting means are dimensioned in such a way that the frequency response of the transporting means are optimised.

3. An assembly according to claim 1, wherein damper grids are placed on an inner surface of the mean for transporting sound to the inlet, which is acting as a sound passage for front volume

4. An assembly according to claim 1, wherein the diameter of the at least two inlet holes for sound are dimensioned according to a required directionality.

5. An assembly according to claim 1, wherein the transporting means are attachable or attached to the microphone.

6. An assembly according to claim 1, wherein at least one of the transporting means comprise a sound-delaying filter.

7. An assembly according to claim 1, for use in a hearing aid.

8. A hearing aid comprising:
a surface part having at least two inlet holes for sound,
a microphone having at least two sound inlets,
hollow and at least substantially rigid means for transporting sound from each inlet hole to a respective sound inlet.

9. A hearing aid according to claim 8, wherein the inner diameter of the hollow transporting means are dimensioned in such a way that the frequency response of the transporting means are optimised.

10. A hearing aid according to claim 8, wherein damper grids are placed on an inner surface of the mean for transporting sound to the inlet, which is acting as a sound passage for front volume.

11. A hearing aid according to claim 8, wherein the diameter of the at least two inlet holes for sound are dimensioned according to a required directionality.

12. A hearing aid according to claim 8, wherein the transporting means are attachable or attached to the microphone.

13. A hearing aid according to claim 8, wherein at least one of the transporting means comprises an acoustical sound-delaying filter.

14. A microphone assembly for use in the hearing aid according to claim 8, the assembly comprising:
a microphone having at least two sound inlets,
hollow and at least substantially rigid means attached to the microphone and being adapted to transport sound from predetermined positions to a respective sound inlet.

15. An assembly according to claim 14, wherein the inner diameter of the hollow transporting means are dimensioned in such a way that the frequency response of the transporting means are optimised.

16. An assembly according to claim 14, wherein damper grids are placed on an inner surface of the mean for transporting sound to the inlet which is acting as a sound passage for front volume.

17. A hearing aid according to any of claims 14, wherein the diameter of the at least two inlet holes for sound are dimensioned according to a required directionality.

18. An assembly according to any of claims 14, wherein the transporting means are adapted to abut or engage an element defining the surface part having sound inlet holes, the transporting means abutting or engaging the element at sound inlet holes thereof.

19. An assembly according to any of claims 14, wherein at least one of the transporting means comprises an acoustical sound-delaying filter.

20. An assembly according to any of claims 14, wherein the sound-delaying filter is adapted to delay sound by a period of time at least substantially corresponding to a distance between two predetermined positions divided by the velocity of sound in air at sea level.

21. An assembly according to any of claims 14, wherein the acoustical sound-delaying filter is adapted to provide a sound delay corresponding to 0.33-0.57 times a distance between two inlet holes in the surface part divided by the speed of sound.
